(19) United States
(12) Patent Application Publication
(10) Pub. No.: US 2014/0014034 A1
(43) Pub. Date: Jan. 16, 2014

(54) TREATMENT BATH WITH WORKPIECE INVERTER

(71) Applicant: Josep Valls BALAGUE, Allella CP-Barcelona (ES)

(72) Inventor: Josep Valls BALAGUE, Allella CP-Barcelona (ES)

(21) Appl. No.: 13/938,342

(22) Filed: Jul. 10, 2013

(30) Foreign Application Priority Data
Jul. 12, 2012 (EP) 12176197.7

(51) Int. Cl. B05C 3/10; C25D 17/06

(52) U.S. Cl. CPC B05C 3/10; C25D 17/06
USPC 118/425; 204/212

(57) ABSTRACT

An apparatus for treating a workpiece with a liquid has a vessel holding a body of the liquid, a mount provided with a holder for carrying the workpiece, and a lifter for shifting the mount with the holder and the workpiece from an upper position above the body of liquid into a lower position with the workpiece immersed in the body of liquid. An inverting mechanism is coupled with the lifter for rotating the mount, holder, and workpiece through about 180° above the body of liquid on movement from the upper position toward the lower position and from the lower position into the upper position.

### FIELD OF THE INVENTION

The present invention relates to an apparatus for treating workpieces by immersing them in a liquid. More particularly this invention concerns a treatment bath.

### BACKGROUND OF THE INVENTION

A typical immersion-treatment apparatus or bath comprises a vessel holding a body of treatment liquid, a mount carrying a workpiece holder loaded with workpieces, and a lifter for lowering the mount from an upper position above the level of the treatment liquid to a lower position in the treatment liquid and for moving it back up from the lower position into the upper position.

A plurality of workpieces are typically secured to the holder. The workpieces are in particular small-scale hollow bodies, for example sleeves and caps that are to be given a high-grade finish. The workpiece holder includes a base frame and slats attached to the base frame, each having a plurality of elastically deformable holding fingers that are arranged in pairs and function to secure the hollow bodies. The treatment liquid contained in the vessel can be, for example, a dye bath, an anodizing bath, an electroplating bath, or the like. Variations in the immersion time can have a significant effect on the dyeing effect and high-gloss finish of the workpieces. In practice it is well known that workpiece holders previously loaded with workpieces to be treated are suspended in a conveyor, transported upright, and vertically dipped into the treatment liquid. The workpieces in the lower region of the workpiece holder are exposed to the treatment liquid for a longer time during this type of process than those workpieces secured in the upper region of the workpiece holder. The variation in residence time in, for example, an anodizing bath and/or a downstream dye bath, has a negative effect on the quality of the workpiece surface. Those surfaces that have been anodized and/or dyed on workpieces that have been secured to the workpiece holder have, for example, differences in terms of color intensity that can be attributed to the different residence times for the workpieces in the dye bath.

An additional problem is the fact that not all of the treatment liquid runs off or drains from the workpieces secured on the vertically oriented workpiece holder when the workpiece holder is lifted out of the bath. This results in significant is carryover losses of treatment liquid when the workpiece holder including workpieces thereon is removed from the treatment liquid and transferred to a subsequent treatment bath.

### OBJECTS OF THE INVENTION

It is therefore an object of the present invention to provide an improved immersion-treatment apparatus or bath.

Another object is the provision of such an improved immersion-treatment apparatus or bath that overcomes the above-given disadvantages, in particular where essentially the same immersion time can be ensured for all workpieces secured to the workpiece holder.

Another object is to provide such an apparatus in which all the liquid drains completely from the workpieces and the workpiece holder when the workpiece holder is removed.

### SUMMARY OF THE INVENTION

An apparatus for treating a workpiece with a liquid has according to the invention a vessel holding a body of the liquid, a mount provided with a holder for carrying the workpiece, and a lifter for shifting the mount with the holder and the workpiece from an upper position above the body of liquid into a lower position with the workpiece immersed in the body of liquid. According to the invention an inverting mechanism is coupled with the lifter for rotating the mount, holder, and workpiece through about 180° above the body of liquid on movement from the upper position toward the lower position and from the lower position into the upper position.

The mount includes a support surface for at least one workpiece holder that in the upper position is preferably oriented horizontally. The workpieces are secured to the horizontally oriented holder in such a way that all the workpieces are in a planar array. Movement of the lifter out of the upper position rotates the mount and the planar workpiece array. Rotation of the mount causes the workpiece holder attached to the mount to be turned, and, after turning from a position above the level of the liquid, to be lowered into the bath liquid by vertical movement of the mount. The workpiece holder performs both straight-line movement and rotation. The inventive design of the immersion bath has the advantage that all of the workpieces secured to the workpiece holder reach the liquid level of the treatment liquid and are immersed in the treatment liquid of the treatment bath substantially simultaneously.

The apparatus according to the invention is thus particularly well suited for immersion processes in which the residence time in the treatment liquid for the workpieces must be set very precisely, and where it is necessary for all the workpieces secured to the workpiece holder to have the same residence time in the bath. It is also advantageous that removal of the workpiece holder be effected by a return movement of the lifter from the lower position in the treatment liquid to the initial position above the level of the liquid. During the return movement, all of the workpieces secured to the workpiece holder also leave the treatment liquid simultaneously. After leaving the treatment liquid, the mount is rotated back through 180°, and the workpiece holder secured to the mount is turned such that the workpieces are oriented above the holder. The overhead position enables the treatment liquid to drain away completely, including from the interiors of the workpieces. This enables carryover losses to be minimized.

The design according to the invention also has the advantage that the kinematics can be derived from straight-line movement of the lifter. No separate drive is required for the rotation. The lifter is outside the vessel containing the treatment liquid and is therefore not exposed to the treatment liquid. Only the guide and inverting mechanism composed of simple mechanical elements is immersed in the treatment liquid.

The mount advantageously includes a C-shaped rail to each side for holding at least one workpiece holder. The C-shaped rails are preferably made of wire elements, thereby enabling the treatment liquid to drain off them and preventing any accumulation of liquid within the C-shaped rails.

The guide and inverting mechanism includes at least one vertical guide and a pivot assembly that is shaped like a three-tooth gear segment and that can be rotatably and displaceably moved along the vertical guide. The pivot assembly is permanently attached to the mount, and includes tooth-like arms having control surfaces that in response to straight-line movement of the pivot assembly come into contact with stop faces of a gear-like stop element fixed on the vertical guide, and in response to a continued straight-line movement effect a 180° pivoting of the pivot assembly due to the interaction with the stop faces.

In a preferred embodiment of the invention, the pivot assembly includes one radial arm on each side of a cavity of the vertical guide, each arm having a concave curved control surface on its bottom side opposite the mount. In response to straight-line movement by the pivot assembly along the vertical guide, the control surfaces successively grasp two vertically spaced rounded stop faces and each cause the pivot assembly to make a 90° rotation. To complete the movement sequence, the pivot assembly includes a projection between the arms that engages into a cavity between the stop faces in response to movement by the control surfaces about the stop faces. The described guide and inverting mechanism is robust, requires little space, and also reliably performs its function even when immersed in the treatment liquid. The elements required for the guide and inverting mechanism can be made of stainless steel, sheet titanium, or other materials that are matched to the specific treatment liquid. In a preferred embodiment of the invention, the mount is carried on a base whose lower face carries the two swivel bodies that are coaxial and synchronously rotated and displaced along a respective vertical guide rail. The described arrangement is well suited in particular for large-format and heavy workpiece holders.

The lifter advantageously includes an actuator as well as a cross-member that is connected to the actuator, the cross-member being vertically movable along guide rails and connected to the guide and inverting mechanism. The rails guiding the cross-member are outside the vessel and are not exposed to the treatment liquid. A pneumatic or hydraulic cylinder/piston arrangement, an electromechanical motor, or an electrical linear drive, in particular, are well suited to function as the actuator.

### BRIEF DESCRIPTION OF THE DRAWING

The above and other objects, features, and advantages will become more readily apparent from the following description, reference being made to the accompanying drawing in which:

FIG. 1 is a side view of the immersion bath;

FIG. 1A is a large-scale view of the detail indicated at 1A in FIG. 1;

FIG. 2 is a top view of the immersion bath shown in FIG. 1; and

FIG. 3 is a simplified schematic view of a guide and inverting mechanism that is part of the immersion bath shown in FIG. 1.

### DETAILED DESCRIPTION OF THE INVENTION

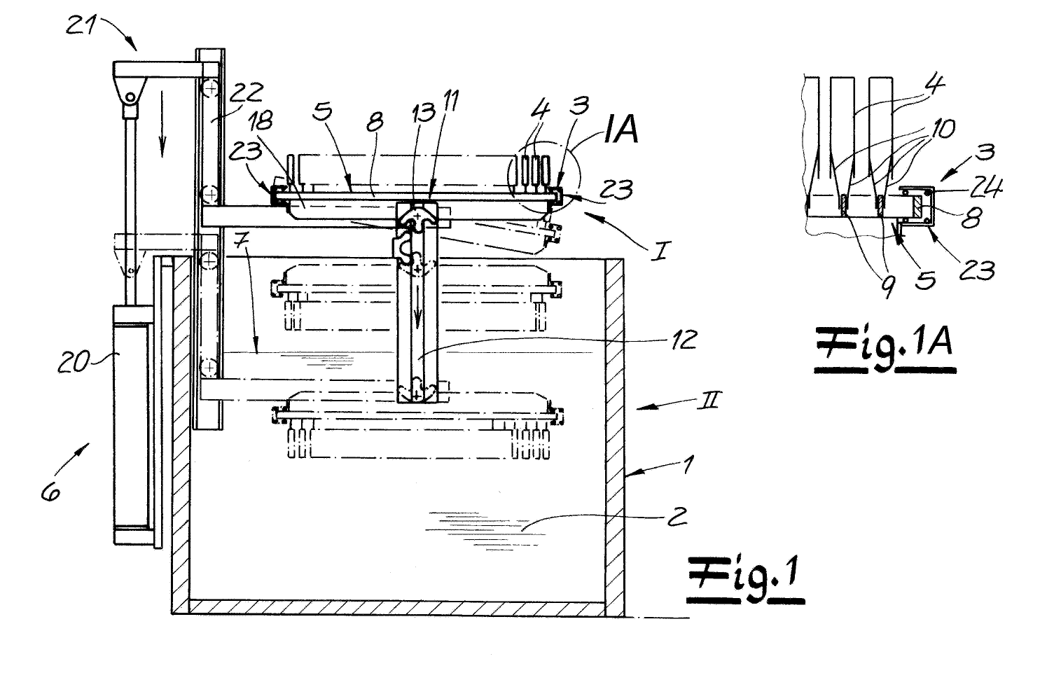

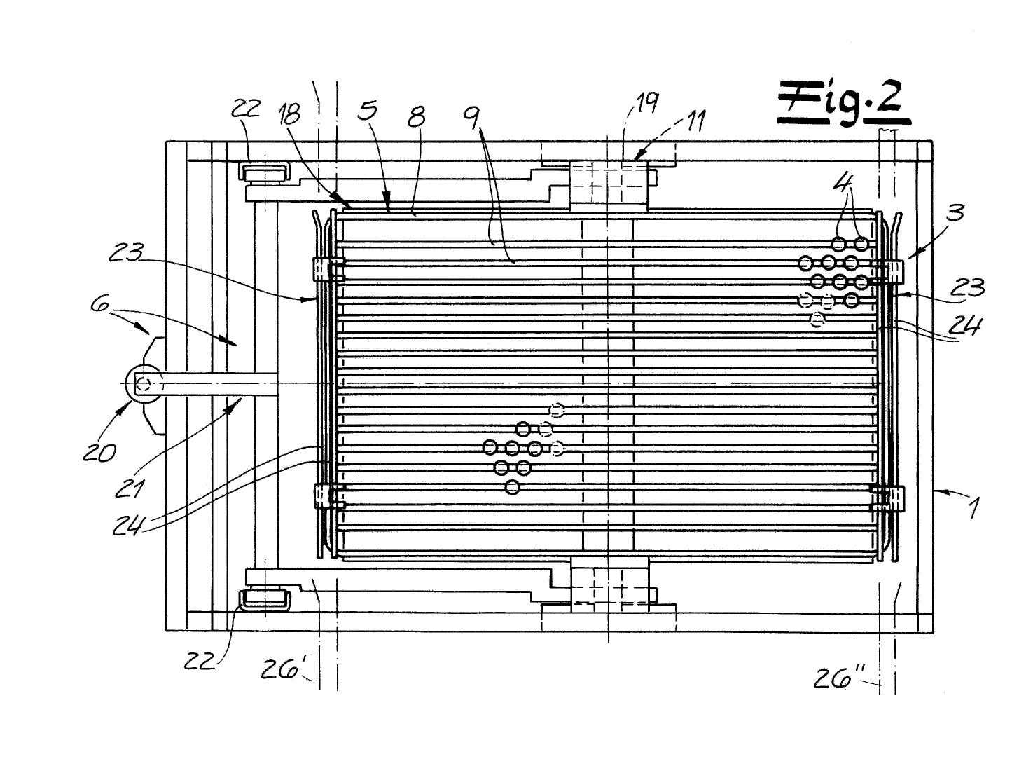

As seen in FIGS. 1 and 2 an immersion-treatment apparatus or bath comprises a vessel 1 holding a body 2 of treatment liquid, a mount 3 carrying a workpiece holder 5 loaded with workpieces 4, and a lifter 6 for lowering the mount 3 along with the holder 5 and the workpieces 4 from an upper position I above an upper surface 7 of the liquid body 2 to a lower position II with the mount 3, holder 5, and workpieces 4 immersed in the treatment liquid 2. The workpiece holder 5 can be separated from the mount 3, which actually forms a lowerable part of a conveyor 26′ and 26″ extending over the vessel 1 in a direction perpendicular to the view plane of FIG. 1 as shown in FIG. 2.

FIGS. 1 and 2 further show that the workpiece holder 5 includes a planar and horizontal base frame 8 provided with an is array of parallel slats 9 attached to the base frame 8 and each having a plurality of pairs of elastically deformable retaining fingers 10 for securing the workpieces 4. The workpieces 4 are small hollow bodies, for example sleeves, caps, or the like that are to be provided with a high-grade decorative surface by treatment in the immersion bath. FIG. 1 shows that the workpiece holder 5 is oriented horizontally in the upper position I such that the fingers 10 project upward from the workpiece holder 5 so that the hollow bodies 4 can be engaged down over the fingers and any liquid can drain away unimpeded from the interiors of the hollow bodies 4.

The mount 3 is connected to a guide and inverting mechanism 11 that moves the mount 3 with the holder 5 and workpieces in a straight line along a vertical travel path extending from the upper position I to the lower position II. At the very start of downward movement, the mechanism pivots the mount 3, holder 5, and workpieces 4 above the liquid level 7 through 180°, and then lowers them in a straight line into the liquid body 2. The rotation is derived from straight-line movement of the lifter 6 and is completed before any part of the holder 5 or any of the workpieces 4 reach the liquid level 7 of the liquid body 2. The described movement kinematics have the advantage that all of hollow bodies 4 secured to the holder 5 reach the treatment liquid simultaneously due to the straight-line lowering movement and are plunged into the liquid while right side up, that while hanging from the fingers 10 and open upwardly. Thus when the holder 5 is immersed in the liquid body 2, the fingers 10 of the holder 5 project vertically downward, with the result that the hollow bodies 4, which are gripped by the fingers 10, are open at their upper ends and the treatment liquid is able to flow into their interiors unimpeded by gas bubbles.

After undergoing treatment for a predetermined residence time in the treatment liquid, the mount 3 is raised in a straight-line return movement until the holder 5 and all of the workpieces 4 are spaced well above the liquid body 2. Once thus elevated above the level of the liquid, reverse pivoting through 180} begins, that is the mount with the holder 5 and workpieces 4 are turned, with the result that the hollow bodies 4 are turned upside-down while still being held by the fingers 10 and liquid can drain unimpeded from the interiors of the workpieces 4 back into the vessel 1.

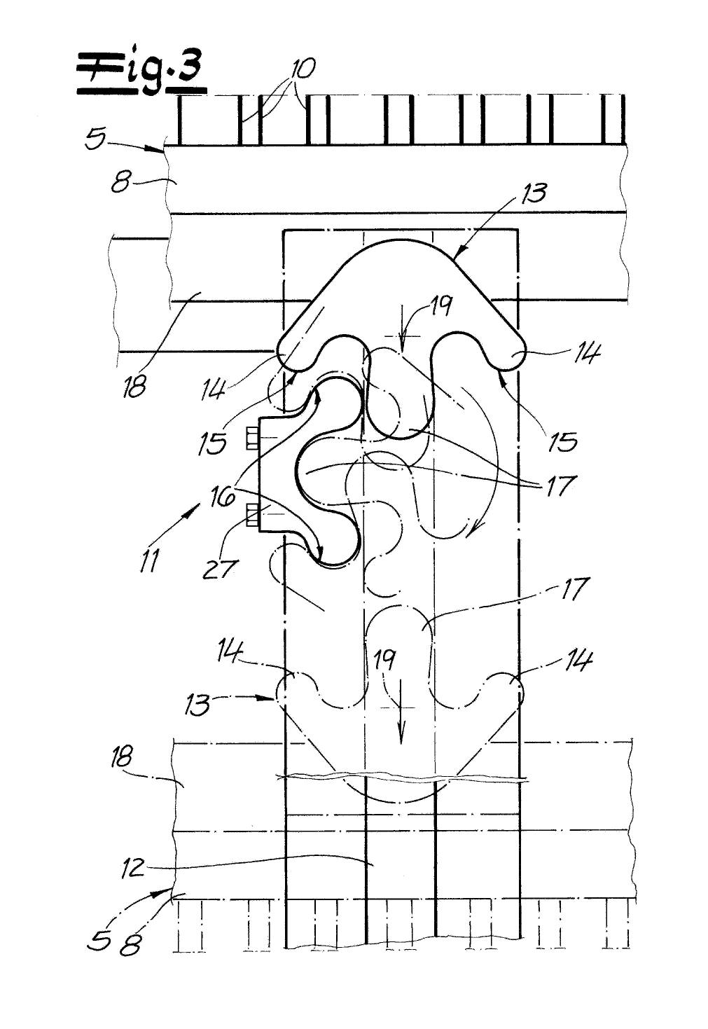

As best shown in FIG. 3, the guide and inverting mechanism 11 has a vertical guide 12 and a pivot assembly 13 that can rotate about a horizontal axis A and is displaceable vertically in a straight line along the vertical guide 12. The pivot assembly 13 is fixed to the mount 3 for the holder 5 for joint rotation about the axis A therewith and has arms 14 flanking a central projection 17 and having control surfaces 15 that in response to straight-line movement of the pivot assembly 13 come sequentially into contact with stop faces 16 and a cavity 25 (FIG. 2) of a stop element 27 bolted to the vertical guide 12, and in response to a continued straight-line movement rotate the pivot assembly 13 through 180° due to interaction of the stop faces 16 with the arms 14 and of the cavity 25 with the projection 17. The interaction of the lifter 6 and the guide and inverting mechanism 11 enables the holder 5, which is attached to the mount 3, to be rotated, then after being turned from a position I above the treatment bath, lowered by a continued vertical movement into the liquid body 2. The schematic simplified diagram in FIG. 3 shows that the pivot assembly 13 has one arm 14 on each side of the central projection 17 and each having a concave curved control surface 15 on its side facing away from the mount 3. In response to straight-line movement of the pivot assembly 13 along the vertical guide 12, the control surfaces 15 successively engage the two vertically spaced rounded stop faces 16 and both make the pivot assembly 13 move through a 90° rotation with the projection 17 fitting in the cavity 17 when the planar holder 5 is in a vertical orientation. To complete the movement and the above-described 90° turn, the projection 17 between the arms 14 engages into a free space or cavity 25 between the stop faces 16 in response to movement by the control surfaces 15 about the stop faces 16. The stop faces 16 can also be formed by spaced bolts.

FIG. 2 shows that the mount 3 is carried on a base 18 whose lower face carries two of the two pivot assemblies 13. The pivot assemblies 13 are coaxial on the axis 19 and are jointly rotatably and displaceably moved along vertical guide 12.

A comparison of FIGS. 1 and 2 furthermore shows that the lifter 6 includes an actuator 20 and a cross-member 21 connected to the actuator 20. The cross-member 21 can be moved vertically along guide rails 22 that are inside the vessel 1, and is connected to the guide and inverting mechanism 11. The actuator 20 in the embodiment is a pneumatic or hydraulic piston/cylinder arrangement. Alternatively, it is also possible to employ an electromechanical actuator or an electrical linear drive as the actuator 20.

The mount 3 includes C-shaped rails 23 on the two opposite sides for carrying the holder 5. Each C-shaped rail 23 is preferably made of wire 24. Both sides of the immersion bath is have respective conveyor rail systems 26′ and 26″ for transfer of a workpiece holder to the immersion bath and movement of the workpiece holder away following the immersion operation.

I claim:

1. An apparatus for treating a workpiece with a liquid, the apparatus comprising:
a vessel holding a body of the liquid;
a mount provided with a holder for carrying the workpiece;
a lifter for shifting the mount with the holder and the workpiece from an upper position above the body of liquid into a lower position with the workpiece immersed in the body of liquid; and
an inverting mechanism coupled with the lifter for rotating the mount, holder, and workpiece through about 180° above the body of liquid on movement from the upper position toward the lower position and from the lower position into the upper position.

2. The liquid-treatment apparatus defined in claim 1, wherein the rotation through about 180° takes place wholly above the body of liquid in the vessel.

3. The liquid-treatment apparatus defined in claim 1, wherein the holder is generally planar and can hold a plurality of the workpieces in a generally planar array, the holder and array of workpieces both being horizontal in the upper position and in the lower position.

4. The liquid-treatment apparatus defined in claim 3, wherein the mount includes a pair of C-section rails between which the holder can be slid and from which the holder can be moved, the rails being generally parallel to an axis about which the mount is rotated on moving into and out of the upper position.

5. The liquid-treatment apparatus defined in claim 4, wherein the C-shaped rails are made of wire, whereby liquid can drain from them.

6. The liquid-treatment apparatus defined in claim 3, wherein the holder has a plurality of parallel workpiece grippers adapted to fit in respective workpieces and projecting upward in the upper position of the mount and downward in the lower position of the mount.

7. The liquid-treatment apparatus defined in claim 6 wherein each workpiece gripper is a pair of elastically spreadable fingers snugly engageable in the workpieces.

8. The liquid-treatment apparatus defined in claim 1 wherein the inverting mechanism includes:
a fixed vertical guide along which the mount can travel in a straight line;
s a gear-like stop element fixed on the guide; and
a pivot assembly formed like a gear segment rotationally fixed on the mount and engageable with the stop element on vertical shifting along the guide past the stop element to pivot the mount through 180°.

9. The liquid-treatment apparatus defined in claim 8, wherein the pivot assembly has two arms and a projection therebetween projecting radially from an axis of rotation of the mount and the stop element forms a pair of stop faces and a cavity meshable with the arms and projection as the pivot assembly moves vertically in the guide past the stop element.

10. The liquid-treatment apparatus defined in claim 8 wherein there are two of the guides horizontally flanking the mount and each carrying a respective one of the stop elements and the mount has two of the pivot assemblies each engageable with a respective one of the stop elements.

11. The liquid-treatment apparatus defined in claim 1, wherein the lifter includes
an actuator outside the vessel;
a cross member outside the vessel and connected to the mount; and
vertical guide rails in which the cross member travels.

12. The liquid-treatment apparatus defined in claim 11 wherein the actuator is a fluid-powered cylinder or an electrical linear drive.

13. The liquid-treatment apparatus defined in claim 11 wherein the vertical guide rails are inside the vessel.
